(19) United States
(12) Patent Application Publication
(10) Pub. No.: US 2012/0221157 A1
(43) Pub. Date: Aug. 30, 2012

(54) LOW PRESSURE SPOOL EMERGENCY GENERATOR

(75) Inventors: Adam M. Finney, (US); Michael Krenz, (US); Carl A. Wagner, (US); David L. Jacques, (US)

(73) Assignee: HAMILTON SUNDSTRAND CORPORATION, Windsor Locks, CT (US)

(21) Appl. No.: 13/036,994

(22) Filed: Feb. 28, 2011

(51) Int. Cl. B60L 1/00; G06F 1/26

(52) U.S. Cl. 700/287; 307/9.1

(57) ABSTRACT

An emergency power system is useable on an aircraft having a gas turbine engine with a low pressure spool and a high pressure spool. The emergency power system includes an emergency electrical generator coupled to the low pressure spool during an emergency for generating emergency electrical power and one or more additional electrical power sources. A plurality of electrical loads are electrically connected to the emergency electrical generator and the one or more additional electrical power sources. Aircraft sensors provide data regarding emergency electrical power availability and emergency electrical power demand. A controller for controlling the emergency electrical generator determines emergency electrical power demand and emergency electrical power availability based upon data from the aircraft sensors. The controller controls the emergency electrical generator based upon the emergency electrical power demand and the emergency electrical power availability.

### CROSS-REFERENCE TO RELATED APPLICATION

Reference is made to application Ser. No. ______ entitled “AIRCRAFT EMERGENCY POWER SYSTEM” which is filed on even date and are assigned to the same assignee as this application, the disclosure of which is incorporated by reference in its entirety.

### BACKGROUND

The present invention relates to power generation on aircrafts, and in particular, to emergency power generation and use thereof.

On a typical gas turbine engine powered aircraft, one or more gas turbine engines are used to provide thrust to propel the aircraft and also to power various electrical and hydraulic loads on the aircraft. One or more hydraulic pumps and electrical generators are typically driven by a high pressure spool on each gas turbine engine. So long as each gas turbine engine is operating normally, each high pressure spool rotates, allowing each hydraulic pump and electrical generator to provide hydraulic and electric power to hydraulic and electric loads on the aircraft. However, if a gas turbine engine fails to operate normally, any hydraulic pump or electrical generator coupled to the high pressure spool of that engine will have its output reduced or eliminated. In an emergency situation in which all thrust-producing gas turbine engines and auxiliary power units fail, the aircraft can be left without any power for its electrical and hydraulic loads.

Some aircrafts are prepared for such emergencies by incorporating emergency power systems. These emergency power systems have one or more emergency power sources, such as a ram air turbine (RAT), to provide emergency power. However, emergency power systems typically do not provide enough power to power all hydraulic and/or electric loads on an aircraft. If an emergency power system is configured to power too many loads during an emergency, the emergency power system can become overloaded, stalling the RAT. Stalling a RAT and/or other emergency power sources can reduce or eliminate power to all loads, including those most necessary for safe operation of the aircraft during the emergency.

### SUMMARY

According to the present invention, an emergency power system is useable on an aircraft having a gas turbine engine with a low pressure spool and a high pressure spool. The emergency power system includes an emergency electrical generator coupled to the low pressure spool during an emergency for generating emergency electrical power and one or more additional electrical power sources. A plurality of electrical loads are electrically connected to the emergency electrical generator and the one or more additional electrical power sources. Aircraft sensors provide data regarding emergency electrical power availability and emergency electrical power demand. A controller for controlling the emergency electrical generator determines emergency electrical power demand and emergency electrical power availability based upon data from the aircraft sensors. The controller controls the emergency electrical generator based upon the emergency electrical power demand and the emergency electrical power availability.

Another embodiment of the present invention includes a method for operating an emergency electrical generator coupled to a low pressure spool of a gas turbine engine during an emergency. The method includes sensing data regarding emergency electrical power availability from the emergency electrical generator and one or more additional electrical power sources. The method further includes sensing data regarding emergency electrical power demand from a plurality of electrical loads electrically connected to the emergency electrical generator and one or more additional electrical power sources. The method further includes controlling the emergency electrical generator based upon the emergency electrical power demand and the emergency electrical power availability.

### BRIEF DESCRIPTION OF THE DRAWINGS

FIG. 1 is a schematic side view of a gas turbine engine for use on an aircraft.

FIG. 2 is a block diagram of an electrical power system for use with the gas turbine engine of FIG. 1 on the aircraft.

FIG. 3 is a block diagram of an emergency power system used as part of the electrical power system of FIG. 2.

### DETAILED DESCRIPTION

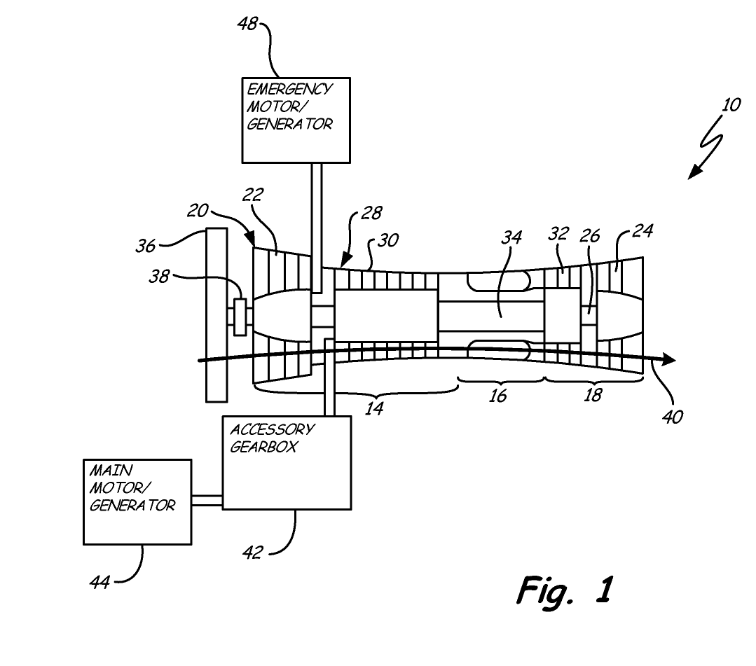

FIG. 1 is a schematic side view of gas turbine engine 10 for use on an aircraft (not shown). Gas turbine engine 10 includes compressor section 14, combustor section 16, and turbine section 18. Low pressure spool 20 (which includes low pressure compressor 22 and low pressure turbine 24 connected by low pressure shaft 26) and high pressure spool 28 (which includes high pressure compressor 30 and high pressure turbine 32 connected by high pressure shaft 34) each extend from compressor section 14 to turbine section 18. Propulsion fan 36 is connected to and driven by low pressure spool 20. A fan drive gear system 38 may be included between the propulsion fan 36 and low pressure spool 20. Air flows from compressor section 14 to turbine section 18 along engine gas flow path 40. The general construction and operation of gas turbine engines is well-known in the art, and therefore detailed discussion here is unnecessary.

Accessory gearbox 42 connects main motor-generator 44 to high pressure spool 28. Main motor-generator 44 can act as an electric motor to drive high pressure spool 28, and can also act as an electrical generator when driven by high pressure spool 28. During normal operation of gas turbine engine 10, high pressure spool 28 drives main motor-generator 44 to generate electrical energy. In an alternative embodiment, main motor-generator 44 can be connected to high pressure spool 28 without using accessory gearbox 42.

Emergency motor-generator 48 is connected to low pressure spool 20. Emergency motor-generator 48 can act as an electric motor to drive low pressure spool 20, and can also act as an electrical generator when driven by low pressure spool 20. In an alternative embodiment, emergency motor-generator 48 can be connected to low pressure spool 20 through gearing (not shown). During an emergency in which gas turbine engine 10 fails to operate normally (for example, if combustion ceases), air forced over propulsion fan 36 can cause propulsion fan 36 to “windmill”. Thus, a windmilling propulsion fan 36 can drive low pressure spool 20, which drives emergency motor-generator 48 to generate electrical energy.

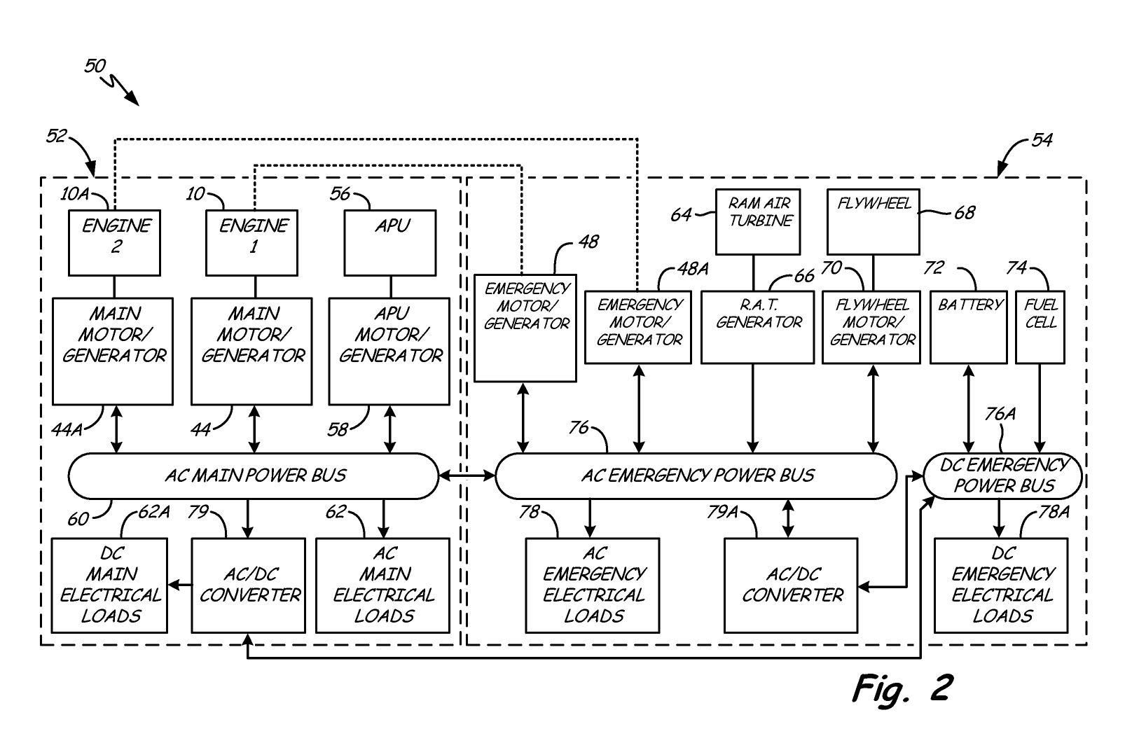

FIG. 2 is a block diagram of electrical power system 50, which include main power system 52 and emergency power system 54. Main power system 52 includes multiple main power sources: gas turbine engine 10 connected to main motor-generator 44, gas turbine engine 10A connected to main motor-generator 44A (which are substantially similar to gas turbine engine 10 and main motor-generator 44, respectively), and auxiliary power unit (APU) 56 connected to APU motor-generator 58. APU 56 includes a gas turbine engine similar to gas turbine engine 10, but APU 56 does not provide propulsive thrust for the aircraft (not shown). In alternative embodiments, main power system 52 can include more or fewer than three main power sources. Each of main motor-generator 44, main motor-generator 44A, and APU motor-generator 58 are connected to AC (alternating current) main power bus 60 for supplying electrical energy to AC main electrical loads 62 and DC (direct current) main electrical loads 62A. During normal operation, AC main electrical loads 62 and DC main electrical loads 62A receive electrical power primarily or exclusively from some combination of gas turbine engine 10, gas turbine engine 10A, and/or APU 56.

Emergency power system 54 includes multiple emergency power sources: emergency motor-generator 48 connected to low pressure spool 20 (shown in FIG. 1) of gas turbine engine 10, emergency motor-generator 48A connected to a low pressure spool (not shown) of gas turbine engine 10A, ram air turbine (RAT) 64 connected to RAT generator 66, flywheel 68 connected to flywheel motor-generator 70, battery 72, and fuel cell 74. Each of emergency motor-generator 48, emergency motor-generator 48A, RAT generator 66, and flywheel motor-generator 70 are connected to AC emergency power bus 76 for supplying electrical energy to AC emergency electrical loads 78. RAT 64 is a turbine that can be deployed into an airstream exterior of the aircraft. Rotating RAT 64 causes RAT generator 66 to also rotate and, consequently, generate and supply electrical power to AC emergency power bus 76. Flywheel motor-generator 70 can convert mechanical energy stored in flywheel 68 to and from electrical energy stored on AC emergency power bus 76.

Battery 72 and fuel cell 74 are connected to DC emergency power bus 76A for supplying electrical energy to DC emergency electrical loads 78A. Battery 72 stores electrical energy from DC emergency power bus 76A and returns electrical energy to DC emergency power bus 76A as needed. Fuel cell 74 can also supply electrical energy to DC emergency power bus 76A.

In the illustrated embodiment, AC emergency power bus 76 is connected to AC main power bus 60, DC emergency electrical loads 78A are connected to AC main power bus 60 via AC/DC converter 79, and DC emergency electrical loads 78A are connected to AC emergency power bus 76 via AC/DC converter 79A. Thus, AC emergency electrical loads 78 can receive electrical power from AC main power bus 60 and/or DC emergency power bus 76A when such power is available. Similarly, DC emergency electrical loads 78A can receive electrical power from AC main power bus 60 and/or AC emergency power bus 76 when such power is available.

AC main electrical loads 62 and AC emergency electrical loads 78 can receive 115 volt three-phase AC power, 235 volt three-phase AC power, or another form of AC power. DC main electrical loads 62A and DC emergency electrical loads 78A can received 28 volt DC power, 270 volt DC power, or another form of DC power. Electrical power system 50, which include main power system 52 and emergency power system 54, is illustrated in a simplified form. In practice, additional electrical connections and/or components (not shown) can be added as needed for particular applications.

During emergency operation in which gas turbine engine 10, gas turbine engine 10A and APU 56 fail to operate normally, and/or in which main power system 52 fails to operate normally, AC emergency electrical loads 78 and DC emergency electrical loads 78A can still receive electrical power from some or all of emergency motor-generator 48, RAT generator 66, flywheel motor-generator 70, battery 72, and fuel cell 74.

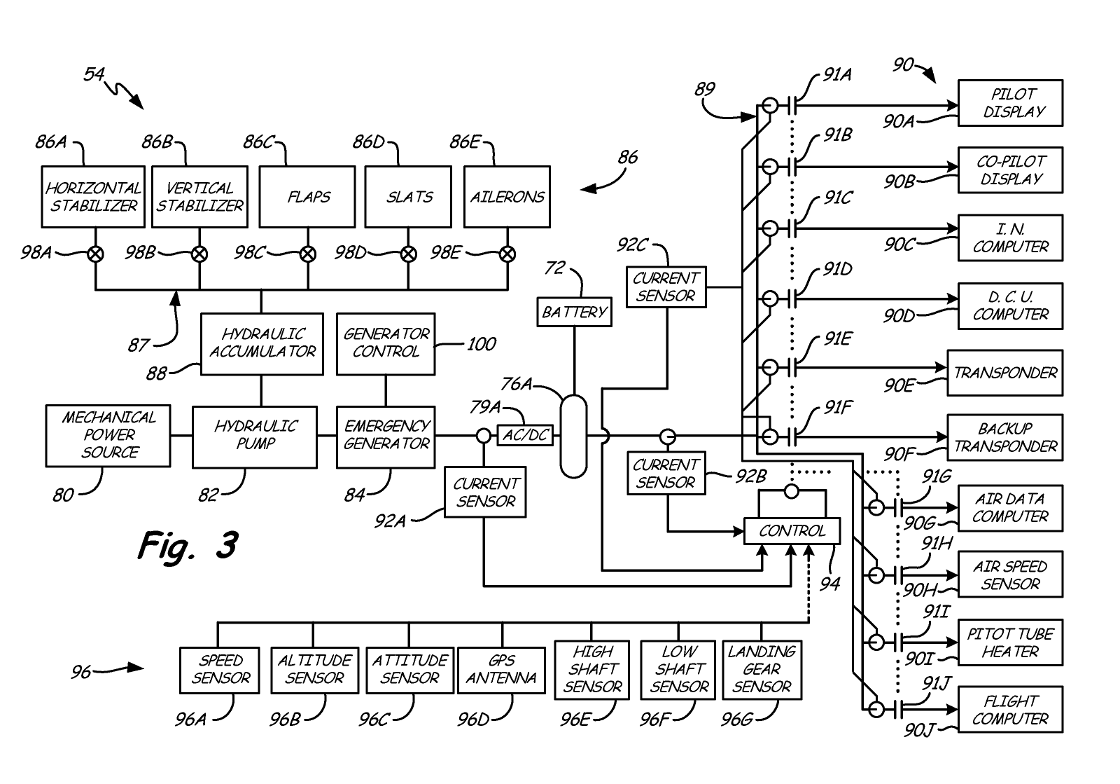

FIG. 3 is a block diagram of emergency power system 54. FIG. 3 illustrates portions of emergency power system 54 in greater detail than in FIG. 2, but is still in a simplified form. In another sense, emergency power system 54 as illustrated in FIG. 3 is simplified to a greater extent than as illustrated in FIG. 2, because FIG. 3 illustrates only a single mechanical power source 80. Thus it should be understood that emergency power system 54 is illustrated in FIG. 3 only as an example. In practice, additional electrical and hydraulic connections and/or components (not shown) can be added as needed for particular applications. Similarly, certain components illustrated in FIG. 3 can be omitted if not needed in a particular embodiment.

Emergency power system 54 includes mechanical power source 80, which drives hydraulic pump 82, which drives emergency generator 84. Mechanical power source 80 can be any suitable source of mechanical power, such as propulsion fan 36 connected to low pressure spool 20 (shown in FIG. 1), RAT 64 (shown in FIG. 2), or flywheel 68 (shown in FIG. 2). Emergency generator 84 can be any suitable electrical generator, such as emergency motor-generator 48 (shown in FIGS. 1 and 2), RAT generator 66 (shown in FIG. 2), or flywheel motor-generator 70 (shown in FIG. 2).

In the illustrated embodiment, hydraulic pump 82 is mechanically connected between mechanical power source 80 and emergency generator 84 to rotate and transmit power there-between. Hydraulic pump 82 is also hydraulically connected to emergency hydraulic loads 86 via hydraulic power distribution network 87 to transmit hydraulic power thereto. Hydraulic accumulator 88 is connected between hydraulic pump 82 and hydraulic loads 86 and acts as a short term energy storage element. Emergency hydraulic loads 86 include one or more of the following: horizontal stabilizer 86A, vertical stabilizer 86B, flaps 86C, slats 86D, and ailerons 86E. Emergency hydraulic loads 86 can also include other hydraulic loads such as landing gear (not shown) and nose wheel steering equipment (not shown). Thus, mechanical power source 80 can provide hydraulic power to emergency hydraulic loads 86 when hydraulic power might otherwise be insufficient or not available. In one embodiment, each emergency hydraulic load 86 can have two or more hydraulic inputs (not shown) to receive power from two or more hydraulic pumps 82. Such hydraulic pumps 82 are each connected to its respective mechanical power source 80. In an alternative embodiment, a given mechanical power source 80 can power multiple hydraulic pumps 82. In still further alternative embodiments, hydraulic loads 86 can be powered electrically instead of hydraulically. In such embodiments, hydraulic pump 82 can be omitted.

Emergency generator 84 is connected to DC emergency power bus 76A via AC/DC converter 79A. Electrical power distribution network 89 connects DC emergency power bus 76A to emergency electrical loads 90. Emergency electrical loads 90 include pilot display 90A, co-pilot display 90B, inertial navigation computer 90C, display control unit computer 90D, transponder 90E, backup transponder 90F, air data computer 90G, air speed data sensor 90H, air speed pitot tube heater 901, and flight computer 90J. Emergency electrical loads 90 can also include other electrical loads such as landing gear (not shown) and nose wheel steering equipment (not shown). Thus, mechanical power source 80 can provide power to emergency electrical loads 90 when electrical power from main power system 52 is insufficient or not otherwise be available. Emergency electrical loads 90A-90J can be AC emergency electrical loads 78 (shown in FIG. 2), DC emergency electrical loads 78A (shown in FIG. 2) or some combination of both AC and DC. Accordingly some of emergency electrical loads 90A-90J may require separate power buses. Regardless of whether emergency electrical loads 90A-90J use DC or AC power, electrical power distribution network 89 can function substantially as described below.

Electrical power distribution network 89 connects emergency generator 84 to emergency electrical loads 90. Electrical power distribution network 89 includes switches 91A-91J for selectively coupling and decoupling each respective emergency electrical load 90A-90J to and from emergency generator 84. Current sensor 92A senses current between emergency generator 84 and AC/DC converter 79A. Current sensor 92B senses current between DC emergency power bus 76A and all emergency electrical loads 90, collectively. Current sensor 92C senses current flowing to each emergency electrical load 90A-90J, individually. Current sensors 92A-92C are connected to and send current signals to controller 94.

Aircraft sensors 96 are also connected to controller 94 for sending signals related to flight, engine, and other aircraft data. In various embodiments, aircraft sensors 96 can be connected directly to controller 94, or can be connected to air data computer 90G, flight computer 90J, and/or another computer (not shown) which process raw data and then send data signals to controller 94. Aircraft sensors 96 include speed sensor 96A (which can be the same as or different than air speed data sensor 90H), altitude sensor 96B, attitude sensor 96C, GPS antenna 96D, high pressure shaft sensor 96E, low pressure shaft sensor 96F, and landing gear sensor 96G.

In an emergency, it is desirable to power all emergency electrical loads 90 and all emergency hydraulic loads 86 if sufficient power is available. However, if sufficient power is not available, attempting to power all emergency electrical loads 90 and all emergency hydraulic loads 86 can slow mechanical power source 80 below its minimum operating limit and cause it to stall, thus reducing or eliminating power available to all emergency electrical loads 90 and all emergency hydraulic loads 86. This can potentially cause complete loss of control of the aircraft with catastrophic results.

Controller 94 determines emergency electrical power availability and emergency electrical power demand based on data from aircraft sensors 96 and current sensors 92A-92C. Emergency electrical power demand can include both present demand from emergency electrical loads 90 and anticipated demand from emergency electrical loads 90 over an anticipated duration of an emergency. Emergency electrical power availability can include both stored electrical power and electrical power anticipated to be generated over an anticipated duration of the emergency. For example, controller 94 can determine present emergency electrical power availability and use that information to determine which emergency electrical loads 90 and emergency hydraulic loads 86 can be presently powered. Additionally, controller 94 can determine emergency electrical power availability over an anticipated duration of an emergency and use that information to determine which emergency electrical loads 90 and emergency hydraulic loads 86 can be powered for some or all of the emergency.

Based upon available information, controller 94 can consider a duration of an expected emergency and generate an expected energy production plan and an expected energy use plan. Available emergency electrical power can be determined from the expected energy production plan. The expected energy use plan is designed to work within the constraints of the available emergency electrical power.

Controller 94 is connected to switches 91A-91J for selectively coupling and decoupling one or more emergency electrical load 90A-90J to and from DC emergency power bus 76A. Similarly, controller 94 can also be connected to valves 98A-98E for selectively coupling and decoupling emergency hydraulic loads 86A-86E to and from hydraulic power distribution network 87. In an alternative embodiment, valves 98A-98E can be connected to and controlled by a separate controller (not shown). Controller 94 can actuate switches 91A-91J and valves 98A-98E in accordance with the expected energy use plan.

Though all emergency electrical loads 90 and emergency hydraulic loads 86 are important in an emergency, some are more important than others. Accordingly, a priority rank can be assigned to each emergency electrical load 90 and also to each emergency hydraulic load 86. For example, priority ranks could be assigned in load schedules as in Table 1 and Table 2:

TABLE 1

| emergency electrical | Priority | Peak Power | Emergency Power |
|---|---|---|---|
| loads 90: | Rank: | Draw (Watts): | Draw (Watts): |
| pilot display 90A | 2 | 600 | 600 |
| co-pilot display 90B | 4 | 600 | 600 |
| inertial navigation | 4 | 200 | 200 |
| computer 90C | | | |
| display control unit | 3 | 400 | 400 |
| computer 90D | | | |
| transponder 90E | 2 | 1000 | 1000 |
| backup transponder 90F | 6 | 1000 | 0 |
| air data computer 90G | 2 | 250 | 250 |
| air speed data sensor 90H | 3 | 60 | 60 |
| air speed pitot tube heater | 5 | 50 | 50 |
| 90I | | | |
| flight computer 90J | 3 | 120 | 120 |

TABLE 2

| Emergency Hydraulic | Priority | Peak Power Draw | Emergency Power |
|---|---|---|---|
| Loads 86: | Rank: | (Watts): | Draw (Watts): |
| horizontal stabilizer 86A | 1 | 5000 | 1200 |
| vertical stabilizer 86B | 8 | 4000 | 0 |
| flaps 86C | 3 | 800 | 400 |
| slats 86D | 7 | 750 | 0 |
| ailerons 86E | 9 | 2000 | 0 |

Tables 1 and 2 show each emergency electrical load 90 and emergency hydraulic load 86 with a numerical priority rank. In the illustrated embodiment, a priority rank of one is the highest priority and a priority rank of ten is the lowest priority. Horizontal stabilizer 86A has a priority rank of one. This means that horizontal stabilizer 86A will always be powered if at all possible. Conversely, ailerons 86E have a priority rank of nine. No emergency load has a priority rank of ten. This means that if any emergency electrical load 90 or emergency hydraulic load 86 must have its power cut, ailerons 86E will lose power first. Each priority rank represents a relative importance of each emergency electrical load 90 and emergency hydraulic load 86 during emergency operation. When there are redundant emergency electrical loads 90, controller 94 can assign different priority ranks to each. For example, in Table 1 above, transponder 90E is assigned a relatively high priority rank of two, while backup transponder 90F is assigned a relatively low priority rank of six. If controller 94 determines that a particular emergency electrical load 90 has failed, controller 94 can assign it a reduced priority rank that is lower than its regular priority rank.

Tables 1 and 2 also show the peak power draw for each emergency electrical load 90 and emergency hydraulic load 86, which is the highest rated power drawn during normal operation.

Tables 1 and 2 further show emergency power draw for each emergency electrical load 90 and emergency hydraulic load 86 for a particular emergency situation. In one embodiment, controller 94 determines that in a particular emergency situation, the expected energy production plan includes available emergency power of 5000 watts. Because 5000 watts is far less than the total peak power draw, controller 94 sets a priority rank threshold of five. Those emergency electrical loads 90 and emergency hydraulic loads 86 with a priority rank between one and five have a combined emergency power draw of 4880 watts. Thus, all emergency electrical loads 90 and emergency hydraulic loads 86 with a priority rank between one and five will receive power, and all emergency electrical loads 90 and emergency hydraulic loads 86 with a priority rank between six and ten will receive no power. This allows controller 94 to ensure the most important emergency electrical loads 90 and emergency hydraulic loads 86 will receive power, even when there is not enough emergency power available to power all loads. In different emergencies, controller 94 can set a priority rank threshold greater than or less than five. In alternative embodiments, each emergency electrical load 90 and emergency hydraulic load 86 can have a priority rank, a peak power draw, and an emergency power draw different from those illustrated in Tables 1 and 2.

Controller 94 can automatically decouple a lowest priority emergency electrical load 90 from emergency generator 84 either in anticipation of electrical power distribution network 89 demanding emergency power in excess of available emergency power or in anticipation of potential shutdown of emergency generator 84. If it is anticipated that electrical power distribution network 89 will continue to demand emergency power in excess of available emergency power even after decoupling the lowest priority emergency electrical load 90, then controller 94 can automatically decouple a next lowest priority electrical load 90 from emergency generator 84. For example, controller 94 can decouple one or more emergency electrical loads 90 in response to controller 94 determining that mechanical power source 80 is anticipated to stall absent the decoupling. Controller 94 can also automatically re-couple one or more emergency electrical loads 90 to emergency electrical generator 84 in response to an increase in the available emergency electrical power. Emergency electrical loads 90 are re-coupled in order, based upon the priority rank assigned to each emergency electrical load 90. Actual current draw by each emergency electrical load 90 can often be substantially less than rated current draw. Consequently, controller 94 determines whether to couple or decouple each emergency electrical load 90 based upon actual current signals from current sensors 92A-92C as well as priority rank assigned to each emergency electrical load 90. Controller 94 can also consider data provided by aircraft sensors 96 in determining whether to couple or decouple a particular emergency electrical load 90.

In a similar manner, controller 94 can also automatically couple and decouple a lowest and/or next lowest priority emergency hydraulic load 86 from hydraulic pump 82 in anticipation of hydraulic power distribution network 87 demanding emergency power in excess of available emergency power.

When emergency power system 54 has multiple mechanical power sources 80 (such as low pressure spool 20, RAT 64, and flywheel 68), each can have a dynamically changing maximum electrical and hydraulic power capacity which can be predicted and balanced. As part of the expected energy production plan, generator controller 100 has an energy extraction plan for operating emergency generator 84. Using, for example, low pressure spool 20 as mechanical power source 80 and emergency motor-generator 48 as emergency generator 84, generator controller 100 can control emergency motor-generator 48 to increase total energy extracted from low pressure spool 20 over an anticipated duration of an emergency, without loading low pressure spool 20 so much so as to cause it and propulsion fan 36 to stall. This can be done by predicting when low pressure spool 20 will have a relatively large amount of energy available for extraction and when it will have a relatively small amount of energy available for extraction.

The energy extraction plan can be developed by controller 94, by generator controller 100, or by both. In the illustrated embodiment, controller 94 and generator controller 100 are separate units that can communicate with one-another. In an alternative embodiment, controller 94 and generator controller 100 can be the same unit. In still further alternative embodiments, one or more additional control units (not shown) can be used to perform some of the functions described with respect to controller 94 and generator controller 100. In any case, the energy extraction plan can be developed based upon emergency electrical power demanded by emergency electrical loads 90 and emergency electrical power availability from emergency generator 84. Generator controller 100 then controls emergency generator 84 according to the energy extraction plan.

Data from sensors 96 is used to anticipate emergency electrical power availability over the course of an emergency. Speed sensor 96A provides data on air speed of the aircraft. Altitude sensor 96B provides data on altitude of the aircraft. Attitude sensor 96C provides data on the current attitude or pitch of the aircraft. GPS antenna 96D provides actual position data for the aircraft, and consequently, distance from a suitable landing strip. All of this data can be used to determine how much power is likely to be generated by air flowing over propulsion fan 36 to drive and rotate low pressure spool 20 (and/or air flowing over RAT 64) in the immediate future and over the course of the entire emergency until a safe landing and a controlled stop has been completed.

High shaft sensor 96E provides data on actual rotation speed of high pressure spool 28 (shown in FIG. 1), which is an indication of how much energy is stored in high pressure spool 28 for potential extraction by main motor-generator 44. Low shaft sensor 96F provides data on actual rotation speed of low pressure spool 20, which is an indication of how much energy is stored in low pressure spool 20 for potential extraction by emergency motor-generator 48. RAT 64 and flywheel 68 can also have shaft sensors (not shown) that function in a similar manner as high shaft sensor 96E and low shaft sensor 96F.

Controller 94 and/or generator controller 100 can signal main motor-generator 44 to rotate high pressure spool 28 for storing energy. This can be done when battery 72 is fully charged and emergency electrical power is being generated in excess of emergency electrical power demand. Then when emergency electrical power generation is exceeded by demand, main motor-generator 44 can extract energy from high pressure spool 28 to recover previously stored energy. Thus, high pressure spool 28 can be used in a manner similar to that of flywheel 68.

Landing gear sensor 96G provides data on the current position (deployed or retracted) of landing gear (not shown). If the landing gear is deployed, it can block air flow and create turbulence over RAT 64, if RAT 64 is positioned behind the landing gear. Thus, landing gear sensor 96G provides data that effectively indicates that power produced by RAT 64 can be expected to decrease.

Data from all sensors 96 and current sensors 92A-92C can help controller 94 and generator controller 100 develop and use expected energy production plans, expected energy use plans, and energy extraction plans, as described above. Thus, emergency power system 54 can provide power for the most important of emergency electrical loads 90 and emergency hydraulic loads 86, without stalling the mechanical power sources 80 on which the loads rely.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. For example, the quantity of emergency electrical loads, emergency hydraulic loads, sensors, and/or other components can be more or fewer than those described above. Additionally, the invention can be used with gas turbine engines that differ from that illustrated in FIG. 1, such as those with more than one high pressure spool and those without a fan drive gear system.

1. An emergency power system for use on an aircraft having a gas turbine engine with a low pressure spool and a high pressure spool, the emergency power system comprising:
an emergency electrical generator coupled to the low pressure spool during an emergency for generating emergency electrical power;
one or more additional electrical power sources;
a plurality of electrical loads electrically connected to the emergency electrical generator and the one or more additional electrical power sources;
aircraft sensors for providing data regarding emergency electrical power availability and emergency electrical power demand; and
a controller for controlling the emergency electrical generator, wherein the controller determines emergency electrical power demand and emergency electrical power availability based upon data from the aircraft sensors, wherein the controller controls the emergency electrical generator based upon the emergency electrical power demand and the emergency electrical power availability.

2. The emergency power system of claim 1, wherein the controller develops an energy extraction plan to increase total energy extracted from a windmilling fan attached to the low pressure spool over an anticipated duration of the emergency based upon the emergency electrical power demand and the emergency electrical power availability, and wherein the controller controls the emergency electrical generator according to the energy extraction plan.

3. The emergency power system of claim 1, wherein the emergency electrical power availability includes stored electrical power and electrical power anticipated to be generated over an anticipated duration of the emergency.

4. The emergency power system of claim 1, wherein the emergency electrical power demand includes present demand from the plurality of electrical loads and anticipated demand from the plurality of electrical loads over an anticipated duration of the emergency.

5. The emergency power system of claim 1, wherein the emergency comprises all thrust-producing gas turbine engines and auxiliary power units failing to operate normally.

6. The emergency power system of claim 1, wherein the controller signals a main motor-generator to rotate the high pressure spool to store energy, and wherein the controller signals the main motor-generator to extract energy from the high pressure spool to recover previously stored energy.

7. The emergency power system of claim 1, wherein the aircraft sensors include a speed sensor, an altitude sensor, an attitude sensor, a GPS antenna, a high pressure shaft sensor, a low pressure shaft sensor, and a landing gear sensor.

8. The emergency power system of claim 1, wherein the aircraft sensors include current sensors for sensing current generated by each of the emergency electrical generator and the one or more additional electrical power sources, and current sensors for sensing current demand by each of the plurality of electrical loads.

9. A method for operating an emergency electrical generator coupled to a low pressure spool of a gas turbine engine during an emergency, the method comprising:
sensing data regarding emergency electrical power availability from the emergency electrical generator and one or more additional electrical power sources;
sensing data regarding emergency electrical power demand from a plurality of electrical loads electrically connected to the emergency electrical generator and one or more additional electrical power sources; and
controlling the emergency electrical generator based upon the emergency electrical power demand and the emergency electrical power availability.

10. The method of claim 9, wherein the emergency electrical power availability includes stored electrical power and electrical power anticipated to be generated over an anticipated duration of the emergency.

11. The method of claim 9, wherein the emergency electrical power demand includes current demand from the plurality of electrical loads and anticipated demand from the plurality of electrical loads over an anticipated duration of the emergency.

12. The method of claim 9, wherein data regarding emergency electrical power availability includes low spool shaft speed.

13. The method of claim 13, wherein data regarding emergency electrical power availability further includes high spool shaft speed and ram air turbine shaft speed.

14. The method of claim 9, and further comprising:
developing an energy extraction plan to increase total energy extracted from a windmilling fan attached to the low pressure spool over an anticipated duration of the emergency based upon the emergency electrical power demand and the emergency electrical power availability; and
controlling the emergency electrical generator according to the energy extraction plan.

15. The method of claim 14, and further comprising:
determining altitude and distance to a suitable landing strip as part of developing the energy extraction plan.

16. The method of claim 14, and further comprising:
determining power needed for a safe landing and coming to a controlled stop as part of developing the energy extraction plan.

17. The method of claim 14, and further comprising:
automatically decoupling one or more of the electrical loads from the emergency electrical generator as part of the energy extraction plan.

18. The method of claim 17, wherein the electrical loads are decoupled based upon a priority rank assigned to each of the electrical loads.

19. The method of claim 9, and further comprising:
driving a main motor-generator to rotate a high pressure spool of the gas turbine engine to store energy in the high pressure spool; and
extracting energy from the high pressure spool via the main motor-generator.

20. The method of claim 9, and further comprising:
driving the low pressure spool via a windmilling fan, wherein the energy extraction plan avoids stalling the windmilling fan during flight.
